(19) United States
(12) Patent Application Publication
(10) Pub. No.: US 2016/0038895 A1
(43) Pub. Date: Feb. 11, 2016

(54) SELF SUPPORTING IN-CONTAINER MIX/BLEND SYSTEM

(71) Applicant: Triad Capital Group, LLC, Columbia Station, OH (US)

(72) Inventor: Daniel John Shramo, Avon, OH (US)

(21) Appl. No.: 14/822,020

(22) Filed: Aug. 10, 2015

Related U.S. Application Data
(60) Provisional application No. 62/035,185, filed on Aug. 8, 2014.

(51) Int. Cl. B01F 15/00; B01F 7/22; B01F 3/12

(52) U.S. Cl. CPC B01F 15/00681; B01F 3/1221; B01F 7/22; B01F 2215/005

(57) ABSTRACT

A mixing apparatus includes a mixing device with a rotatable shaft and at least one blade. The mixing apparatus also includes a shaft guide having a central portion and a head portion attached to the central portion. The central portion and the head portion together define an aperture extending from the proximal end to the distal end such that the proximal end and the distal end are in fluid communication through the aperture. The shaft guide provides all axial and radial bearing support for the mixing device such that no other radial or axial support is used when the mixing device operates within an associated container. In other examples, a shaft bushing is located around a portion of the mixing device.

### CROSS-REFERENCE TO RELATED APPLICATIONS

This application claims the benefit of U.S. Provisional Application No. 62/035,185, filed Aug. 8, 2014, the entire disclosure of which is hereby incorporated herein by reference.

### BACKGROUND OF THE DISCLOSURE

1. Field of the Disclosure

The present disclosure relates to a device for mixing a fluid medium. The present disclosure further relates to an apparatus for mixing a fluid medium provided in a pinless container.

2. Discussion of Prior Art

Use of fluid agitation devices within a container is known. Such devices can be used, for example, to agitate paint within a drum in order to at least partially mix pigments in the form of solids with the liquid portion of the paint. However, these devices often require support structure at the bottom of the container for centering, stabilization and support. Thus, there is a need for both improvements to liquid mixing devices to decrease the construction time and cost while enabling mixing operations in standard containers.

### BRIEF DESCRIPTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

According to one aspect, the subject application involves a mixing apparatus including a mixing device. The mixing device includes a rotatable shaft and at least one blade. The mixing apparatus also includes a shaft guide having a central portion with a first outside diameter. The shaft guide also includes a head portion attached to the central portion. The head portion includes a second outside diameter that is greater than the first outside diameter of the central portion. The shaft guide further includes a proximal end located at an edge of the head portion and a distal end located at an edge of the central portion opposite the head portion. The central portion and the head portion together define an aperture extending from the proximal end to the distal end such that the proximal end and the distal end are in fluid communication through the aperture. The shaft guide provides all axial and radial bearing support for the mixing device such that no other radial or axial support is used when the mixing device operates within an associated container.

According to another aspect, the subject application involves a mixing apparatus including a mixing device. The mixing device includes a rotatable shaft and at least one blade. The mixing apparatus also includes a shaft guide having a central portion with a first outside diameter. The shaft guide also includes a head portion attached to the central portion. The head portion includes a second outside diameter that is greater than the first outside diameter of the central portion. The shaft guide further includes a proximal end located at an edge of the head portion and a distal end located at an edge of the central portion opposite the head portion. The central portion and the head portion together define an aperture extending from the proximal end to the distal end such that the proximal end and the distal end are in fluid communication through the aperture. The mixing apparatus further includes a shaft bushing including an inner diameter and an outer diameter, wherein the shaft bushing is located around the rotatable shaft.

According to another aspect, the subject application involves a mixing apparatus for mixing fluid within an intermediate bulk container comprising a mixing device including a rotatable shaft and at least one blade. The mixing apparatus also includes a shaft guide including a central portion and a head portion attached to the central portion. The shaft guide also includes a proximal end located at an edge of the head portion and a distal end located at an edge of the central portion opposite the head portion. The mixing apparatus further includes a shaft bushing including an inner diameter and an outer diameter. The shaft bushing is located around the rotatable shaft. The central portion and the head portion together define an aperture extending from the proximal end to the distal end such that the proximal end and the distal end are in fluid communication through the aperture.

### BRIEF DESCRIPTION OF THE DRAWINGS

The foregoing and other aspects of the apparatus and methods will become apparent to those skilled in the art to which the apparatus and methods relate upon reading the following description with reference to the accompanying drawings, in which:

FIG. 1 shows a perspective cut-away view of an embodiment of one example mixing device placed within a container according to at least one aspect of the present disclosure;

FIG. 2 is an elevation cross-section front view of the mixing device of FIG. 1 used with a mixing apparatus;

FIG. 3 is a side view of the mixing apparatus taken along line 3-3 of FIG. 2;

FIG. 4 is a side view of an example shaft guide from the mixing apparatus of FIG. 2;

FIG. 5 is a top view of the shaft guide of FIG. 4;

FIG. 6 is a cross-section view of the shaft guide taken along line 6-6 of FIG. 5;

FIG. 7 is a perspective view of a shaft bushing from the mixing apparatus of FIG. 2;

FIG. 8 is a top view of the shaft bushing of FIG. 7;

FIG. 9 is cross-section view of the shaft bushing taken along line 9-9 of FIG. 8;

FIG. 10 is a perspective view of a mixing apparatus and showing the relationship of the shaft bushing, the shaft guide, and a rotatable shaft during assembly;

FIG. 11 is a cross-section view of the shaft bushing, the shaft guide, and a rod of the mixer after assembly;

FIG. 12 is a partial cut-away view of another embodiment of a mixing apparatus in an intermediate bulk container;

FIG. 13 is a side view of an example shaft guide from the mixing apparatus of FIG. 12;

FIG. 14 is a bottom view of the shaft guide from the mixing apparatus of FIG. 12;

FIG. 15 is a cross-section of the shaft guide from the mixing apparatus of FIG. 12;

FIG. 16 is a cross-section view of the shaft guide, shaft bushing, and a cap from the mixing apparatus of FIG. 12;

FIG. 17 is a perspective exploded view of the mixing apparatus of FIG. 12;

FIG. 18 is a partial side view of a mixing device of FIG. 12 in an open position; and

FIG. 19 is similar to FIG. 18, showing the mixing device in a folded position.

### DETAILED DESCRIPTION

Example embodiments that incorporate one or more aspects are described and illustrated in the drawings. These illustrated examples are not intended to be limiting. For example, one or more aspects of the apparatus and methods can be utilized in other embodiments and even other types of devices. Moreover, certain terminology is used herein for convenience only and is not to be taken as a limitation.

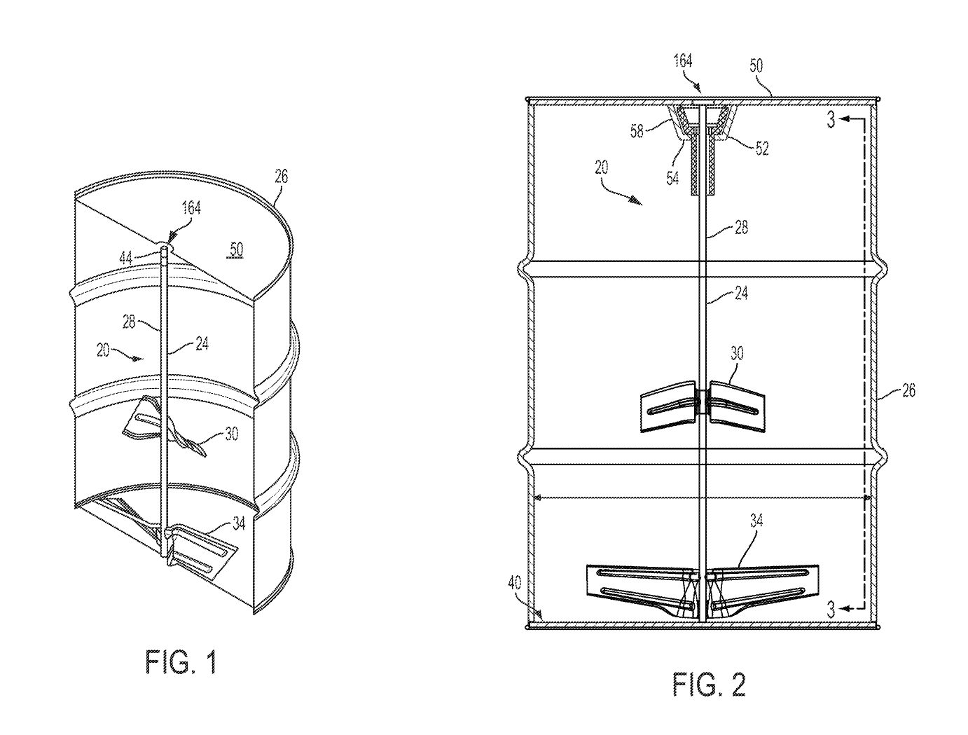

An example embodiment of a mixing device 24 is shown in FIG. 1. The mixing device 24 is shown in one example arrangement within a container 26. It is to be appreciated that FIG. 1 merely shows one example of possible structures/configurations/etc. and that other examples are contemplated within the scope of the present disclosure. FIG. 1 is a three-dimensional cut-away view of the mixing device 24 located within the container 26. In one example, the container 26 can be substantially similar to a standard 55-gallon drum. In another example, the container can be a standard 55-gallon drum.

Turning to FIG. 2, the mixing device 24 is shown in a cross-sectional view with additional components to form a mixing apparatus 20. It should be noted that although the mixing apparatus 20 and associated methods are described with respect to the example arrangement including a mixing device of a particular size used within a 55-gallon drum, one of ordinary skill in the art should understand that the presently described apparatus is not limited to such a use. Rather, the presently described apparatus may be used with any type of container in which fluids are to be mixed, including containers of various sizes, shapes, and numerous fluids stored within those containers, etc. Some specific examples include, but are not limited to drums of 105-gallon, 34-gallon, and 15-gallon capacity as well as containers known as “buckets.”

Other examples can include bulk containers storing fluids in metal, plastic, cardboard, or any combination of these materials. Some of these containers are known as “intermediate bulk containers” or IBC, bins, totes, etc. In other examples, the container 26 can be portable with the mixing device placed within the container 26 prior to placing a quantity of fluid within the container 26. The portable container can then be transported to various locations where the quantity of fluid is desired and the mixing apparatus 20 used prior to a desired application of the fluid.

The mixing device 24 includes a rotatable shaft 28. The mixing device 24 is configured to rotate within the container 26, and the rotatable shaft 28 provides a central rotation axis. In one example, the rotatable shaft 28 has a circular cross-section and can be constructed of any suitable material.

At least one blade is attached to the rotatable shaft 28. In the shown example, there is an upper blade 30 and a lower blade 34 attached to the rotatable shaft 28 at two different elevations. However, it is to be understood that any number of blades and/or combinations of different blades can be used in the present disclosure. For the purposes of this disclosure, the distal end 36 of the rotatable shaft 28 is the end of the rotatable shaft 28 that is inserted into a container toward what would typically be a “closed end” or the “bottom end.”

Of course, the blade material and construction dimensions can be calculated and selected to meet the demands of various mediums that are to be mixed/pumped/blended with the disclosed devices and methods. Additionally, various structures, bends, ridges, etc. can be added to the blades to provide structural strength suitable for particular mixing operations without adding material thickness to the lower blade. For example, if a specific material to be mixed has a relatively low viscosity and relatively low density, a thinner gauge sheet steel and the sheet steel can have a lower ultimate tensile strength in order to reduce the cost and manufacturing demands of the mixing device 24. Conversely, mixing applications requiring higher torque values can also necessitate a thicker gauge sheet steel and a higher value ultimate tensile strength. It is also to be understood that the fluids to be mixed can sometimes be characterized as being highly corrosive. These particular fluids may require special coatings or materials in the construction of the mixing device 24.

While the remainder of the disclosure refers to the fluid primarily in terms of paint, it is to be appreciated that paint is merely one example, and the fluid can be any number of fluids including, but not limited to, paint, chemicals, or any other fluid or colloid, etc. that may benefit from being mixed. In another example, the fluid can also comprise a quantity of solid particles which flow as a fluid when being mixed. In yet another example, the fluid can comprise multiple constituent fluids of different densities and/or viscosities.

Each of the blades 30, 34 can include structural elements to improve various aspects of the design and/or the operation of the device, such as ribs, secondary pumping blades, curvature of the blades 30, 34 in one or more planes, etc. The distance of the blade 30, 34 elements from the lower surface or side walls of the container 26 can also be selected to improve operation of the mixing apparatus. Many of these design and manufacturing considerations are discussed in U.S. patent application Ser. No. 14/037,895, and several of the blades discussed in that patent application are examples of blades that can be used in the mixing apparatus 20 of the present disclosure.

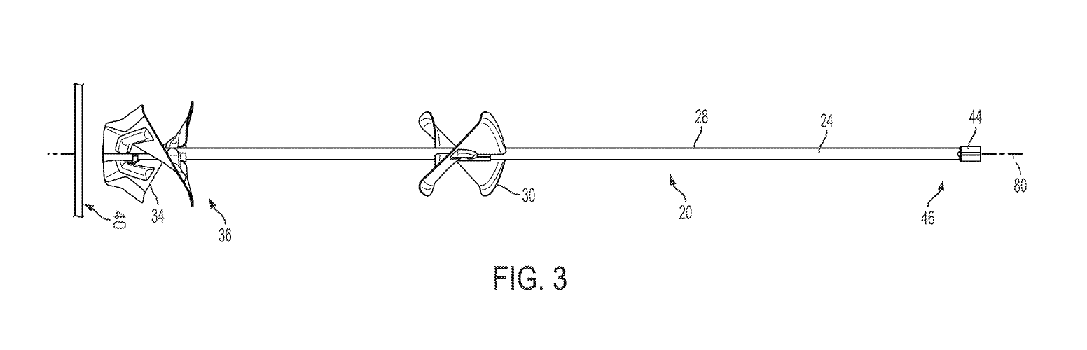

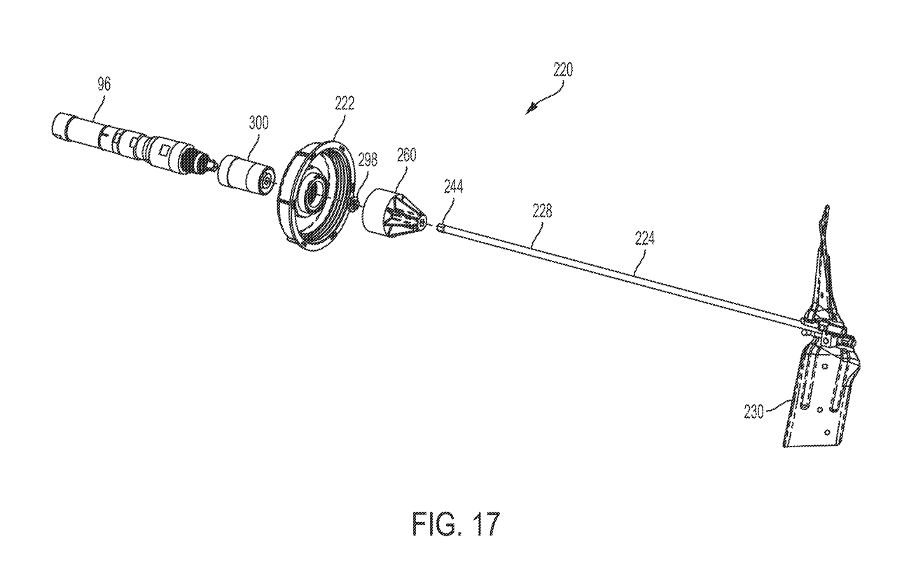

Turning to FIG. 3, the mixing device 24 can include a hub 44 located at a proximal end 46 of the mixing device 24, which can be at the proximal end 46 of the rotatable shaft 28. The hub 44 can be a drive fitting configured to interact with a drive member 300 (best seen in FIG. 17) of a driving device, for example a conventional air motor 96. In one example, the hub 44 is a male, square drive fitting configured to be inserted into a square, female drive component of an air motor 96. In another example, one end of the hub 44 includes a rounded shape or a chamfered edge to help facilitate the mating of the male square drive fitting of the hub 44 into a square, female drive component of an air motor 96 or any other suitable driving device. Although a square drive component is described, it is to be appreciated that the hub 44 can be of any suitable configuration. As shown in FIG. 17, the hub 44 can be hexagonal, while FIG. 3 shows a square hub. In the shown example, the male, square drive fitting is a forged end of the rotatable shaft 28, however, the drive fitting can be a separate member attached to the rotatable shaft 28 by any suitable method as is known in the art. In another example, the hub 44 can be warm-headed at about 800° F. to be formed from the rotatable shaft 28.

Returning to FIG. 2, a lid 50 of a standard 55-gallon drum (or any other container used in conjunction with this disclosure) can include an associated support device 52. The associated support device 52 can include a ring 54 or other surface configured to interact with the shaft on the mixing device 24. In one example, the ring 54 can be attached to the lid 50 via at least one arm 58 so that the ring 54 is placed within the internal volume of the 55-gallon drum when the lid 50 is in its closed position. In certain particular examples, the associated support device 52 can include three arms 58 and define three open spaces between the three arms 58 as they extend away from the lid to secure the ring 54. The associated support device 52 can be crimped into the lid. In one particular example, a toroidal volume is created between the associated support device 52 and the lid when it is crimped into place. In another particular example, the associated support device 52 can be a standard fitting, such as a Visegrip D-200 model agitator bracket assembly as manufactured by Rieke Packaging Systems. The proximal end 46 of the mixing device 24 (e.g., the proximal end of the shaft) can extend through the ring 54.

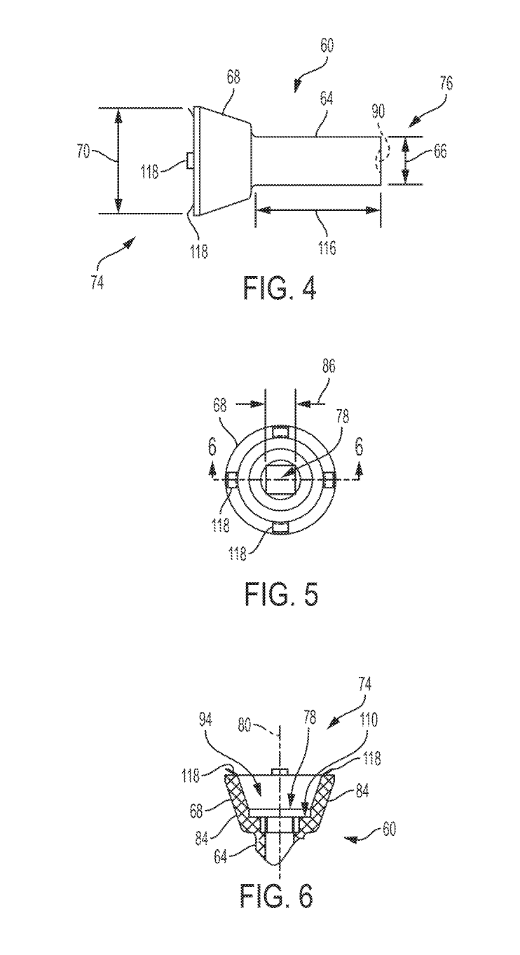

Turning to FIG. 4, a shaft guide 60 can be placed within the associated support device 52 to provide axial and radial bearing support for the rotatable shaft within the associated support device 52. The shaft guide includes a central portion 64 which includes a first outside diameter 66. The shaft guide 60 also includes a head portion 68 attached to the central portion 64. The head portion 68 includes a second outside diameter 70, and this second outside diameter 70 is greater than the first outside diameter 66 of the central portion 64. In one example, the shaft guide 60 is a generally solid piece composed of polyoxymethylene material (POM), which can also be known as acetal, polyacetal, or polyformaldehyde. However, any number of suitable materials or combinations thereof may be used. In another example, the shaft guide 60 is an injection molded component that can include walls of generally the same thickness throughout, however, the injection molding process is but one example, and any number of suitable processes can be utilized to produce the shaft guide 60. The injection molded material can be any number of materials depending upon the intended application for mixing and the materials to be mixed.

The shaft guide 60 also includes a proximal end 74 which is located at an edge of the head portion 68. The shaft guide 60 also includes a distal end 76 which is located at an edge of the central portion 64. The proximal end 74 and the distal end 76 being at opposite ends of the shaft guide 60. As shown in FIG. 5, the central portion 64 and the head portion 68 together define an aperture 78 extending from the proximal end 74 to the distal end 76 such that the proximal end 74 and the distal end 76 are in fluid communication through the aperture 78. The aperture 78 can be centered about a central axis of the shaft guide 60.

Turning to FIG. 6, the exterior sides 84 of the shaft guide 60, particularly the head portion 68 can be positioned at a non-zero angle from the central axis 80 such that the sides 84 of the head portion 68 can be placed in surface contact with the angled arm(s) 58 of the associated support device 52.

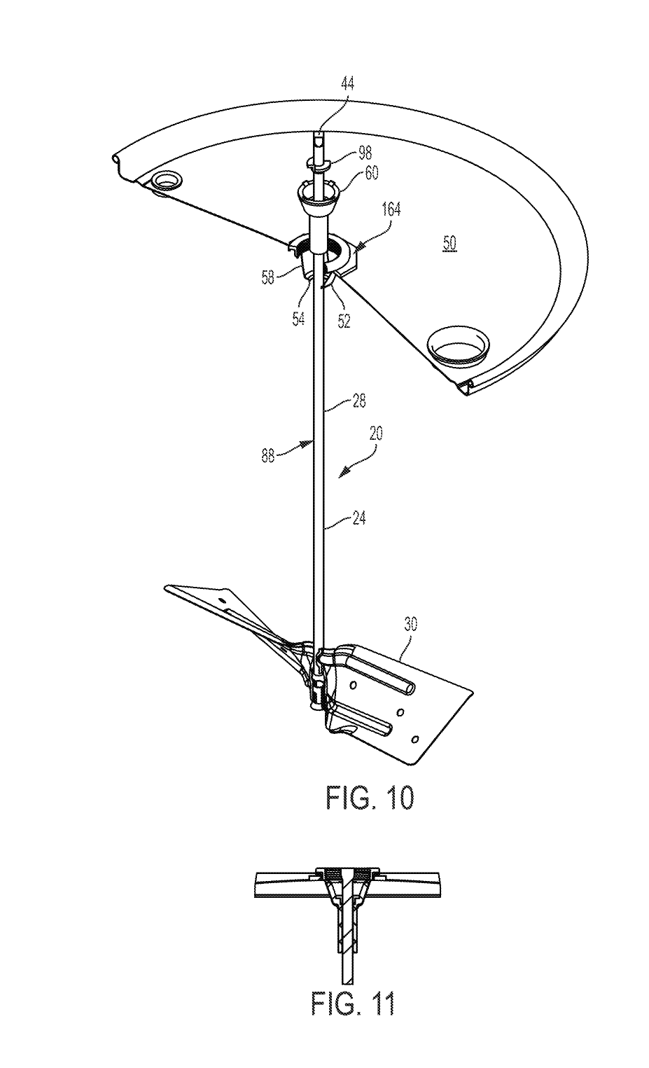

In one example, the central portion 64 is generally cylindrical, however any suitable cross-sectional shape can be used, so long as the central portion 64 can be passed through the associated support device 52. Regardless of the outside shape of the central portion 64, the aperture 78 can also define any number of geometric shapes in cross-section including, but not limited to, circular, hexagonal or square cross-sections. In one particular example, the aperture 78 is defined by a square cross-section and enables the square hub 44 to pass through the aperture 78. A dimension 86 of the square aperture 78 across the flats can also be about 0.005-inch to about 0.008-inch greater than a diameter 88 of the rotatable shaft 28 (best seen in FIG. 10). This enables any fluid, such as paint, to drain out of the shaft guide 60 if it is splashed into the space, as the corners of the square-shaped aperture 78 provide clearance between the cylindrical rotatable shaft 28 and the square cross-section of the aperture 78. This also prevents “freeze” of wet materials that can harden as they dry, such as paint. Even in a freeze condition, relatively little force is required to release the rotatable shaft 28 from the inner walls of the square aperture 78 because there is very little surface contact area between the rotatable shaft 28 and the square aperture 78. A chamfer 90 can be added to the square aperture 78 where the rotatable shaft 28 is inserted into the shaft guide 60 in order to ease the proper alignment of the rotatable shaft 28 to the aperture 78 and ease insertion of the rotatable shaft 28.

While not necessary, other structure can be added to the shaft guide 60 such as tabs or fingers that interact with the spaces between the arms 58 of the associated support device 52. While very little to no rotation of the shaft guide is exhibited in the shaft guide during the mixing operation, the tabs or fingers can extend through the spaces to prevent rotational motion of the shaft guide 60 relative to the associated support device 52. With this structure, the shaft guide 60 can be said to be “clocked.” Other examples of the shaft guide 60 do not require it to be clocked.

The proximal end 74 of the shaft guide 60 can also include a recessed area 94 such that a female drive component of driving device can cooperate with the hub 44 when the mixing device 24 is in its operable location within a container 26. Any suitable driving device can be used to rotate the mixing device 24 including, but not limited to, a hydraulic motor, an air motor 96 (best shown in FIG. 17), an electric motor, a hand crank, etc. In another example, one end of the hub 44 includes a rounded shape or a chamfered edge to help facilitate the mating of the male square drive fitting of the hub 44 into a square, female drive component of the air motor 96 or any other driving device.

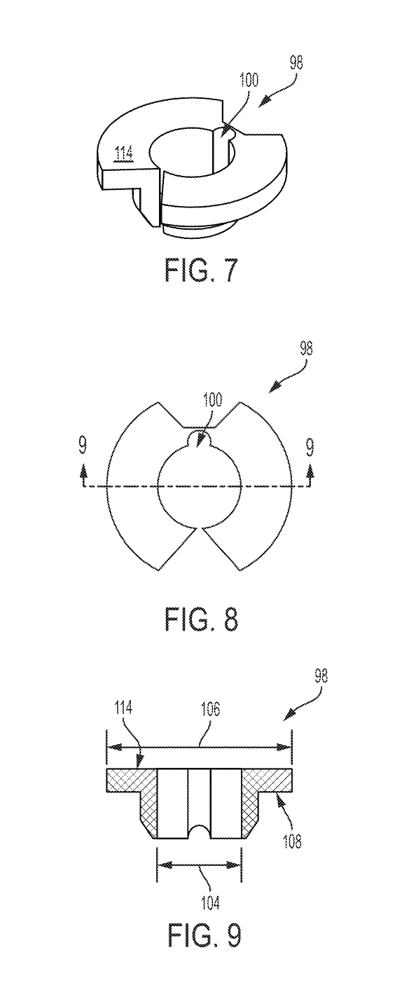

In another example, the mixing apparatus 20 can include a shaft bushing 98, which is shown in the perspective view of FIG. 7. The shaft bushing 98 can also be known by other terms such as keeper, keeper ring, split bushing, collar, etc. Turning to FIG. 8, the shaft bushing 98 can be split along a vertical axis such that the end portions of the shaft bushing 98 can be separated by an operator and then the shaft bushing 98 can be placed around the rotatable shaft 28 of the mixing device 24. The shaft bushing 98 can include a vertical channel 100 to create a thinner section of the shaft bushing 98 that can act as a hinge between the two halves of the shaft bushing 98. In one example, the shaft bushing 98 is located near the proximal end 46 of the mixing device 24 (best seen in FIGS. 10-11).

As shown in FIGS. 7-9, the shaft bushing 98 can be a substantially cylindrical member having an inner diameter 104 and an outer diameter 106. The shaft bushing 98 further includes an exterior surface 108 configured to cooperate with an interior surface 110 (best shown in FIG. 6). These cooperating surfaces 108, 110 can accurately locate the shaft bushing 98 in the axial and radial directions within the shaft guide 60. Additionally, the geometry of the cooperating surfaces 108, 110 can both prevent the shaft bushing 98 from passing entirely through the shaft guide 60 due to physical interference. Any suitable material can form the shaft bushing 98, and in one particular example, the shaft bushing 98 is constructed of nylon. Whatever the choice of material, it may be beneficial to include materials having low coefficients of friction between the shaft bushing 98 and the adjoining components of the shaft guide 60 and the rotatable shaft 28.

Turning to FIG. 10, a partial assembly view is shown. When placing the mixing apparatus 20 into the container 26, the proximal end 46 of the rotatable shaft 28 is passed through the ring 54 in the associated support device 52 and, if necessary, through an aperture in the lid 50. The shaft guide 60 is then passed over the proximal end 46 of the rotatable shaft 28 such that the hub 44 passes through the aperture 78. As previously noted, the cross-sectional shape of the hub 44 (e.g., square) can match the cross-sectional shape (e.g., square) of the aperture 78. An operator can then spread open the shaft bushing 98, and apply it to the rotatable shaft between the hub 44 and the shaft guide 60. It is to be appreciated that at least one diameter of the hub 44 (e.g., across the points of the square cross-section) is longer than the inner diameter 104 of the shaft bushing 98, and as such, the hub 44 is unable to pass through the inner diameter 104 of the shaft bushing 98. Then, as the operator lowers the mixing device 24 into the container 26, the weight of the mixing device 24 will urge the shaft bushing 98 to seat itself within the shaft guide 60 and urge the shaft guide 60 to locate itself within the associated support device 52 to reach the positions shown in FIG. 11.

It is to be appreciated that a top surface 114 of the shaft bushing 98 (best seen in FIG. 9) acts as a bearing surface for at least a portion of the hub 44 of the mixing device 24 and provides axial support for the mixing device 24. Additionally, the cooperating surfaces 108, 110 can act as bearing surfaces. It is also to be noted that the length 116 of the central portion 64 (best shown in FIG. 4) can be designed and manufactured to provide adequate radial support to reduce and/or eliminate deviation of the rotatable shaft 28 from its intended substantially vertical orientation.

Returning to FIGS. 4-6, the mixing apparatus can further include a biasing member to take-up manufacturing tolerances between said shaft guide and an associated container cap. Any suitable biasing member can be used, and in one example, the biasing member can be placed between a cap (not shown) for the bung of the container 26 and the top surface of the shaft guide 60. The biasing member helps ensure the mixing apparatus 20 is at a particular desired axial location, or elevation, within the container 26 and that the shaft guide 60 is firmly located against the associated support device 52. In a particular example, the biasing member can comprise tabs or flanges 118 that are integrally formed into the shaft guide 60 as shown in FIGS. 4-6. The examples show four flanges 118 offset 90° from one another, however, any suitable number of biasing members can be formed into the shaft guide 60, such as two biasing members offset 180° from one another.

One benefit of the described mixing apparatus 20 is the shaft guide 60 working alone or a combination of the shaft guide 60 and the shaft bushing 98 provides axial and radial bearing support for the rotatable shaft 28 within the associated support device 52. In other words, the shaft bushing 98 and said shaft guide 60 provide the entire axial and radial bearing support for the rotatable shaft 28 during shipping, storage, and operation such that there is no additional axial or radial support structure for the mixing device 24. The bearing support during operation precludes the need for any associated structure at the bottom interior surface of the container. This eliminates the need for any structure attached to the container 26 such as a pin-like structure that extends substantially perpendicularly away from the floor 40 of the container 26. The shaft guide also eliminates the need for a cooperating cage located on the mixing device 24 to cooperate with the pin-like structure or other container structure. Instead, the mixing device 24 is stabilized, centered, and supported such that there is no need for other structure during shipping, storage, or operation. The mixing device 24 can be rotated and remain centered radially and positioned axially without any supporting structure at the bottom of the container 26. This can be of particular benefit for containers constructed of plastic, and containers including a thin, protective liner which precludes the use of support pins and similar structure at the bottom of the container. This can also eliminate a manufacturing process for standard 55-gallon drums such that a standard 55-gallon drum (without pins at the bottom) can be used for a fluid mixing operation with little or no required modification. Another benefit to the described structure is the enablement of using such a mixing apparatus 20 with a lined container 26. Previously known structures including pin-like supports on the bottom surface 40 of the container 26 can preclude the use of flexible linings within the container.

In some instances, the mixing device 24 is inserted into the drum by the drum manufacturer. In the event that the 55-gallon drum is sent to another location in order to be filled with a fluid (e.g., paint), a lid 50 is then placed over the open end of the 55-gallon drum. The lid 50 can define a hole 164 (best seen in FIG. 1) or a bung. The hole 164 can be located on or substantially on the central axis of the 55-gallon drum. The lid 50 can include the previously described ring 54 or other surface configured to interact with the shaft guide 60 on the mixing apparatus 20. In one example, the ring 54 can be attached to the lid 50 via at least one arm 58 so that the ring 54 is placed within the internal volume of the 55-gallon drum when the lid 50 is in its closed position. The proximal end 46 of the mixing device 24 (e.g., the proximal end of the rotatable shaft) can extend through the ring 54 and through the shaft guide such that the drive head is exposed at the proximal end of the shaft guide. Thus, the mixing device 24 is held in place during movement, storage, shipment, and operation entirely by the shaft guide and the ring 54 attached to the lid 50. In one example, the lid 50 can serve as a splash guard to prevent the fluid within the container from escaping during a mixing operation.

As noted above, the 55-gallon drum can be sent to another location in order to be filled with a fluid (e.g., paint). A paint manufacturer and a paint distributor are both examples of a location where the 55-gallon drum can be filled with paint. The lid 50 is then removed, and a quantity of paint is placed within the interior space of the 55-gallon drum. The lid 50 is then re-attached and secured by any means as are known in the art. In another example, the lid 50 remains attached to the 55-gallon drum during the filling process, and the filling operation is completed through any available hole or bung in the lid 50 or in any other portion of the 55-gallon drum.

In some cases, the paint manufacturer sends the 55-gallon drum containing the paint and the mixing device 24 to an end user. Frequently, paints include a quantity of particulate matter that in the form of pigment. In one example, these pigments are evenly suspended throughout a liquid component of the paint, forming a colloid. However, the pigments often settle to the lowest point of any container thereby leaving the colloid so that the paint is then made up of a liquid component and a quantity of particulate matter pigment that has settled to the bottom of a container 26. In order to have even paint color distribution during the paint application process, it is often desirable to mix the paint prior to paint application.

The end user can then remove a cap from the hole 164 in the lid 50 of the 55-gallon drum to gain access to the proximal end 46 of the mixing device 24. As previously described, the proximal end 46 of the mixing device 24 includes a hub 44. The end user can then place a driving device such as an air motor 96 (e.g., an air drill, best seen in FIG. 17) in communication with the hub 44, activate the air motor 96, and rotate the mixing device 24 in order to mix the paint within the 55-gallon drum. In one example, a portion of the air motor 96 and/or a fitting 300 attached to the air motor 96 extends through the hole 164 and at least partially into the internal volume of the 55-gallon drum. As such, the lid 50 of the 55-gallon drum does not need to include a seal between the mixing device 24 and the lid 50 or other external wall of the 55-gallon drum, as the mixing device 24 can be located entirely within the internal volume of the 55-gallon drum. The described mixing device 24 is configured to move the particulate matter pigment away from the bottom of the 55-gallon drum, place the particulate matter pigment back into a colloid condition, and evenly distribute the pigment throughout the 55-gallon drum.

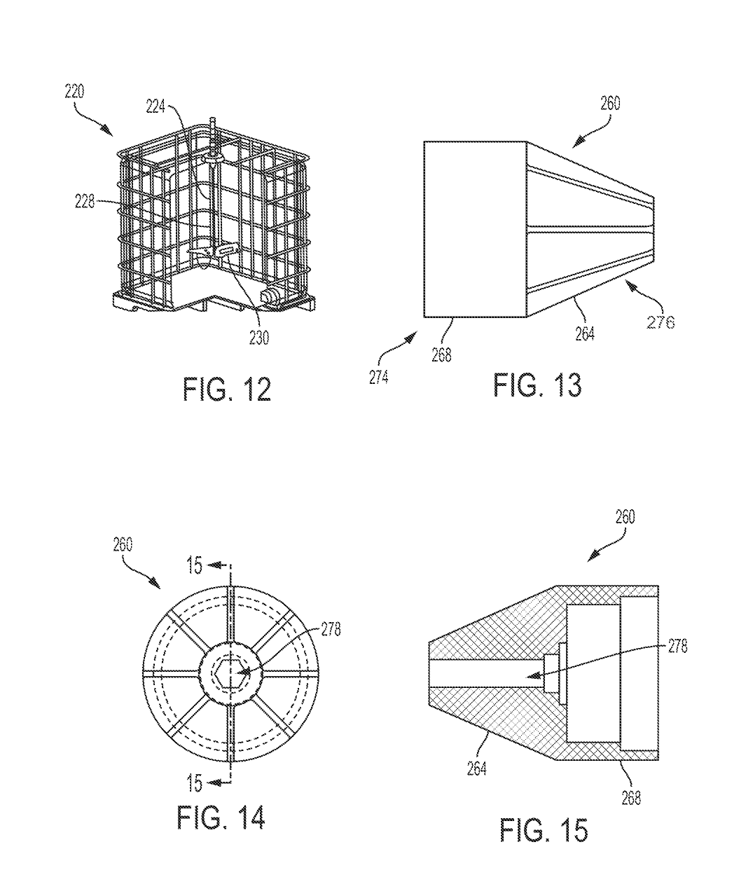

Turning to FIG. 12, a second embodiment of the mixing apparatus 220 including a mixing device 224 is shown in a cut-away view of an intermediate bulk container (IBC) 226. Similar to the first embodiment, the IBC mixing apparatus 220 includes the mixing device 224 including a rotatable shaft 228 and at least one blade 230. The shown example portrays the mixing device 224 employing a single blade 230, however, any suitable number of blades 230 can be used.

Turning to FIG. 13, the mixing apparatus 220 also includes a shaft guide 260 including a central portion 264 and a head portion 268 attached to the central portion 264. The shaft guide 260 further includes a proximal end 274 located at an edge of the head portion 268 along with a distal end 276 located at an edge of the central portion 264 opposite the head portion 268. The central portion 264 and the head portion 268 together define an aperture 278 extending from the proximal end 274 to the distal end 276 such that the proximal end 274 and the distal end 276 are in fluid communication through the aperture 278. As shown in FIG. 14, the aperture 278 is defined by a hexagonal cross-section, and the hub 244 (best shown in FIG. 17) is also hexagonal. However, any suitable cross-section is satisfactory.

Again similar to the first embodiment, the mixing apparatus 220 includes a shaft bushing 298 including an inner diameter and an outer diameter. The shaft bushing 298 is located around the diameter of the rotatable shaft 228 and provides axial support and a bearing surface for the mixing device 224. The mixing apparatus 220 provides the benefit of the shaft guide 260 and the shaft bushing 298 providing the entire axial and radial bearing support for the rotatable shaft 228 during shipping, storage, and operation such that no other radial or axial support is used for the mixing device 224 within the associated IBC.

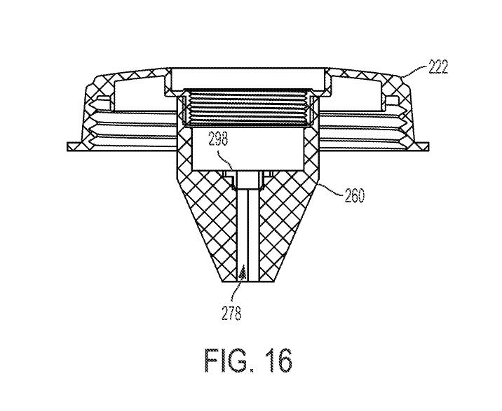

Turning to the cross-section view of FIG. 16, the shaft guide 260 is configured to cooperate with a standard IBC cap 222. The shaft guide 260 can cooperate and/or be attached to the standard IBC cap 222 in any suitable fashion including, but not limited to, snap fit, threaded engagement, press fit, etc. In another example, the shaft guide 260 is permanently attached to the standard IBC cap 222 by a method such as plastic welding. In yet another example, the shaft guide 260 is formed integrally to the standard IBC cap 222 by a method such as plastic injection molding or any other suitable method.

Turning to the exploded view of FIG. 17, the mixing apparatus 220 can be assembled as follows. The mixing device 224 is inserted into the shaft guide 260, maintaining the proper radial rotation between the hexagonal hub 244 and the hexagonal aperture 278 to allow passage. Per the description in the above paragraph, the shaft guide 260 may need to be attached to the IBC cap 222, or alternatively, the shaft guide 260 may already be attached to the IBC cap 222. The shaft bushing 298 is then spread apart and placed around the rotatable shaft 228. The IBC cap 222 is then applied to the IBC (e.g., by threaded connection). An air motor 96 can then be connected to the hub 244, and in some instances, may need a conversion piece 300 to drive the hub 244 and thus mix the contents of the IBC.

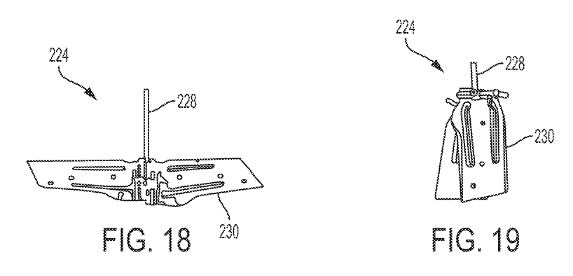

Turning to FIGS. 18 and 19, the mixing device 224 can include other features such as folding blades 230. In some instances, the blades 230 may need to be folded to the position shown in FIG. 19 in order to pass the mixing device 224 through the standard 6-inch hole provided in most standard IBCs. During the mixing operation, centrifugal force will open the folded blades 230 to the position shown in FIG. 18. Any suitable hinging or folding mechanism is satisfactory so long as it is durable enough to withstand the mixing process, particularly in the fluid being mixed.

The apparatus and methods have been described with reference to the example embodiments described above. Modifications and alterations will occur to others upon a reading and understanding of this specification. Example embodiments incorporating one or more aspects of the apparatus and methods are intended to include all such modifications and alterations.

What is claimed is:

1. A mixing apparatus comprising:
a mixing device including a rotatable shaft and at least one blade; and
a shaft guide comprising:
a central portion, wherein said central portion includes a first outside diameter;
a head portion attached to said central portion, wherein said head portion includes a second outside diameter, said second outside diameter is greater than said first outside diameter of said central portion;
a proximal end, said proximal end located at an edge of said head portion; and
a distal end, said distal end located at an edge of said central portion opposite said head portion,
wherein said central portion and said head portion together define an aperture extending from said proximal end to said distal end such that said proximal end and said distal end are in fluid communication through said aperture,
wherein said shaft guide provides all axial and radial bearing support for said mixing device such that no other radial or axial support is used when said mixing device operates within an associated container.

2. The mixing apparatus according to claim 1, wherein said central portion comprises a cylindrical shape.

3. The mixing apparatus according to claim 1, wherein said aperture is symmetrically located about a central axis.

4. The mixing apparatus according to claim 1, wherein said head portion comprises a frusto-conical shape.

5. The mixing apparatus according to claim 1, wherein said shaft guide comprises a polyoxymethylene material.

6. The mixing apparatus according to claim 1, wherein said shaft guide further includes a chamfer on said distal end to aid insertion of said rotatable shaft.

7. The mixing apparatus according to claim 1, further comprising a biasing member to take-up manufacturing tolerances between said shaft guide and an associated container cap.

8. The mixing apparatus according to claim 7, wherein said biasing member is integrally formed into said shaft guide.

9. The mixing apparatus according to claim 1, wherein said shaft guide provides the entire axial and radial bearing support for the associated rotatable shaft during shipping and operation such that no further support of the associated rotatable shaft is required on any interior surface of an associated container within which said mixing apparatus is located.

10. A mixing apparatus comprising:
a mixing device including a rotatable shaft and at least one blade;
a shaft guide comprising:
a central portion, wherein said central portion includes a first outside diameter;
a head portion attached to said central portion, wherein said head portion includes a second outside diameter, said second outside diameter is greater than said first outside diameter of said central portion;
wherein said central portion and said head portion together define an aperture extending from said proximal end to said distal end such that said proximal end and said distal end are in fluid communication through said aperture
a proximal end, said proximal end located at an edge of said head portion; and
a distal end, said distal end located at an edge of said central portion opposite said head portion, and
a shaft bushing including an inner diameter and an outer diameter, wherein said shaft bushing is located around said rotatable shaft.

11. The mixing apparatus according to claim 10, wherein said shaft bushing and said shaft guide provide the entire axial and radial bearing support for said rotatable shaft during shipping, storage, and operation such that there is no additional axial or radial support structure for said mixing device.

12. The mixing apparatus according to claim 10, wherein said shaft bushing comprises a nylon material.

13. The mixing apparatus according to claim 10, wherein said shaft bushing is split such that said shaft bushing can be passed around said rotatable shaft.

14. The mixing apparatus according to claim 10, wherein said rotatable shaft includes a first diameter and a second diameter, wherein said inner diameter of said shaft bushing enables passage of said first diameter of said rotatable shaft through said shaft bushing and prevents passage of said second diameter of said rotatable shaft through said shaft bushing.

15. The mixing apparatus according to claim 10, wherein said shaft bushing further includes an exterior surface configured to cooperate with an interior surface of said shaft guide.

16. A mixing apparatus for mixing fluid within an intermediate bulk container comprising:
a mixing device including a rotatable shaft and at least one blade;
a shaft guide comprising:
a central portion;
a head portion attached to said central portion;
a proximal end, said proximal end located at an edge of said head portion; and
a distal end, said distal end located at an edge of said central portion opposite said head portion, and
a shaft bushing including an inner diameter and an outer diameter, wherein said shaft bushing is located around said rotatable shaft,
wherein said central portion and said head portion together define an aperture extending from said proximal end to said distal end such that said proximal end and said distal end are in fluid communication through said aperture.

17. The mixing apparatus according to claim 16, wherein said shaft guide and said shaft bushing provide the entire axial and radial bearing support for said rotatable shaft during shipping, storage, and operation such that no other radial or axial support is used for said mixing device within an associated intermediate bulk container.

18. The mixing apparatus according to claim 16, wherein said shaft guide is configured to cooperate with a standard intermediate bulk container cap.

19. The mixing apparatus according to claim 16, wherein said shaft guide is permanently attached to a standard intermediate bulk container cap.

20. The mixing apparatus according to claim 16, wherein said shaft guide is formed integrally with a standard intermediate bulk container cap.
